(19) United States
(12) Patent Application Publication
(10) Pub. No.: US 2010/0229839 A1
(43) Pub. Date: Sep. 16, 2010

(54) Hydrogen fuel enhancement system

(76) Inventor: Thomas Fornarelli, JR., Elmhurst, IL (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/381,616

(22) Filed: Mar. 13, 2009

(51) Int. Cl. F02M 27/04

(52) U.S. Cl. 123/538

(57) ABSTRACT

A hydrogen fuel enhancement system for an internal combustion engine includes a container, an electrolyzer and a controller, the controller includes a pulse width modulator for adjustably controlling the frequency and wavelength of power provided to the electrolyzer. The controller is also coupled to a number of sensors, allowing it to monitor and control the functioning of the system.

### TECHNICAL FIELD

The present subject matter relates generally to a system for generating hydrogen gas from water. More particularly, the present subject matter relates to a hydrogen fuel enhancement system for an internal combustion engine.

### BACKGROUND

A typical internal combustion engine, such as those found in automobiles, trucks, boats, and other vehicles, utilizes hydrocarbon fuels for combustion. The combustion of hydrocarbon fuels is not completely efficient, and produces emissions that pollute the atmosphere. It is therefore desirable to improve the efficiency of combustion engines and to reduce the harmful emissions generated when using hydrocarbon fuels in an internal combustion engine.

Hydrogen gas is highly combustible and creates fewer harmful emissions than hydrocarbon fuels when combusted. Indeed, it is known that hydrogen gas can be added to the combustion chamber of an internal combustion engine burning hydrocarbon fuel to improve the efficiency and reduce emissions of such engines.

However, hydrogen gas is extremely volatile, and difficult to store and transport. Thus, use of hydrogen gas in vehicles is limited by safety concerns. While it is known that electrolyzers can be used to generate a mixture of hydrogen gas and oxygen gas (sometimes referred to as HHO or Brown's gas) from water, the electrolyzers can be unreliable in harsh environments, such as when used with an automobile, thus limiting the overall benefits of adding hydrogen to the combustion chamber. Additionally, such systems often require the use of added electrolytes to assist the electrolysis process. Use of electrolytes can create undesirable by-products which also make such systems unreliable. The by-products can also affect the efficiency of the electrolyzer. Other complications can arise in known electrolysis systems.

It is therefore desirable to have a reliable hydrogen generation system which can efficiently generate hydrogen gas.

### SUMMARY

The present concepts provide a system for generating hydrogen gas which can be used in an internal combustion engine.

It is an object to improve the efficiency of and reduce pollutants generated by an internal combustion engine which uses hydrocarbon fuels, by introducing hydrogen gas as a supplemental fuel.

It is another object of the present subject matter to provide a system which efficiently generates hydrogen gas through electrolysis.

It is a further object to provide a hydrogen generation system which is reliable and resistant to overheating, and has improved longevity and performance.

It is an object of the present subject matter to provide a system which can monitor and provide feedback regarding the system's conditions, such as the system's fluid level, temperature and pressure.

The following drawings and description set forth additional advantages and benefits of the subject matter. More advantages and benefits will be obvious from the description and may be learned by practice of the subject matter.

### BRIEF DESCRIPTION OF THE DRAWINGS

The present subject matter may be better understood when read in connection with the accompanying drawings, of which:

FIG. 1 is an exploded, perspective view of a housing and mounting bracket for a hydrogen generation system.

FIG. 2 is a side view of the assembled housing and mounting bracket shown in FIG. 1.

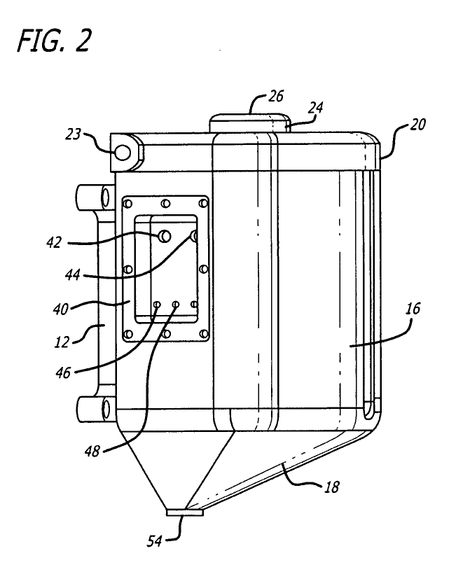

FIG. 3 is a front view of the assembled housing and mounting bracket shown in FIG. 1.

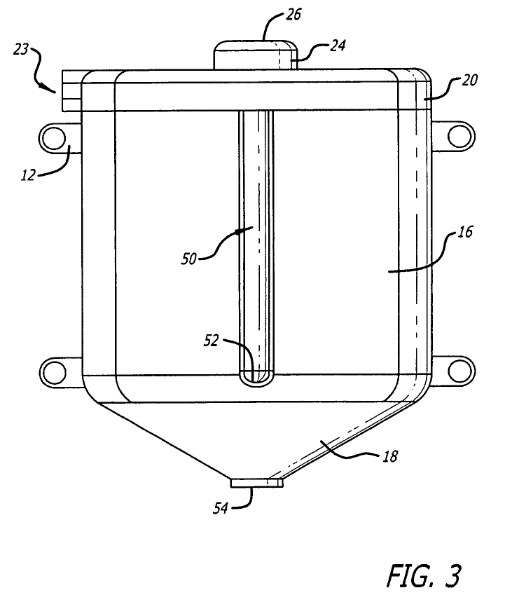

FIG. 4 is a schematic diagram of a hydrogen generation system.

FIG. 5 is a schematic diagram of the output of a DC to DC converter that may be used with a hydrogen generation system.

FIG. 6 is a schematic diagram of another example of a hydrogen generation system.

FIGS. 7A and 7B are schematic diagrams of another example of a hydrogen generation system.

### DETAILED DESCRIPTION

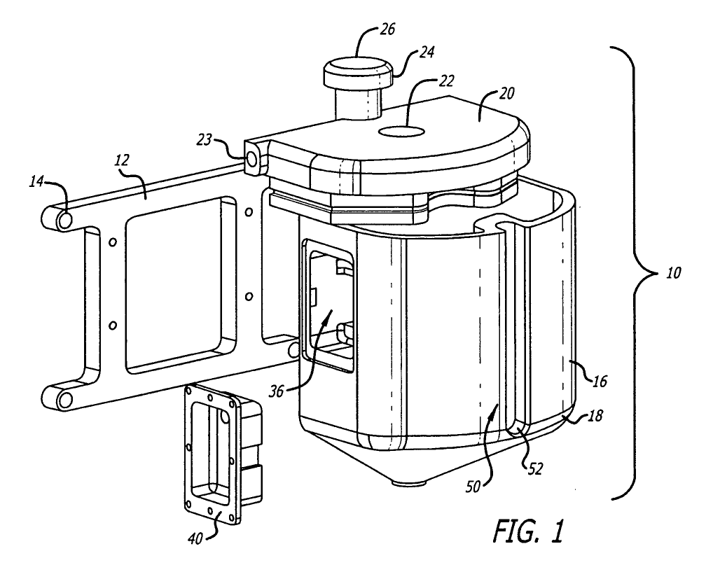

FIG. 1 shows a housing 10 and mounting bracket 12 of the present hydrogen generation system. The system can be used to generate hydrogen gas, in the form of a mixture of hydrogen gas and oxygen gas from water. The mixture, sometimes referred to as HHO or Brown's gas, can be used in connection with internal combustion engines, for vehicles such as automobiles, trucks or boats. The housing 10 can be mounted to a vehicle (not shown) via the mounting bracket 12. The mounting bracket 12 can be mounted directly to the vehicle. Rubber bushings 14 may be used in the mounting bracket 12 to help reduce vibrations.

The housing 10 can be made of plastic, such as Schedule 40 PVC or fiber reinforced polymer composites, or any other material that is impact resistant, and withstands heat and corrosion. It may be desirable for the housing material to be able to withstand temperatures of up to about 225 degrees Fahrenheit. The material may also be impact resistant. The mounting bracket 12 can be metal or any suitable plastic material, such as one similar to the housing.

The housing 10 shown in FIG. 1 has a main section 16 and a tapered section 18. The housing 10 also has a removable top 20. The top 20 can be attached to the main section 16, such as by being snap fit or pressure fit into the main section 16, to form a sealed housing 10.

As shown, the top 20 has a hole 22 in a top surface. The hole 22 can be used to fill or refill the housing 10 with fluid. A removable cap or plug 24 can be used to seal the hole 22. The cap 24 may be threaded or pressure fit within the hole 22 to keep it in place. The cap 24 may have a center pressure seal 26, which allows gas or liquid to escape from the housing 10 to relieve pressure within the sealed housing 10 in the event the internal housing pressure exceeds a certain desired level. For example, a seal 26 can be used which allows the pressure to be released if the internal housing pressure exceeds 7 psi.

The interior of the housing 10 is in fluid communication with the air intake of an internal combustion engine (not shown). As shown, the top 20 includes a duct 23 into which tubing (not shown) can be fit, to connect or couple the housing 10 to the air intake of an internal combustion engine. However, other ducting, tubing, piping, or any other similar connection through which gas can flow can be used.

The size of the housing 10 can vary depending upon the application in which it is to be used. For example, the main section 16 of the housing 10 can be about 12 inches wide by 12 inches high and 6 inches deep, for use with typical automobiles. Of course other sizes and dimensions may be used for a particular application. The tapered section 18 can be about 2 inches in overall height.

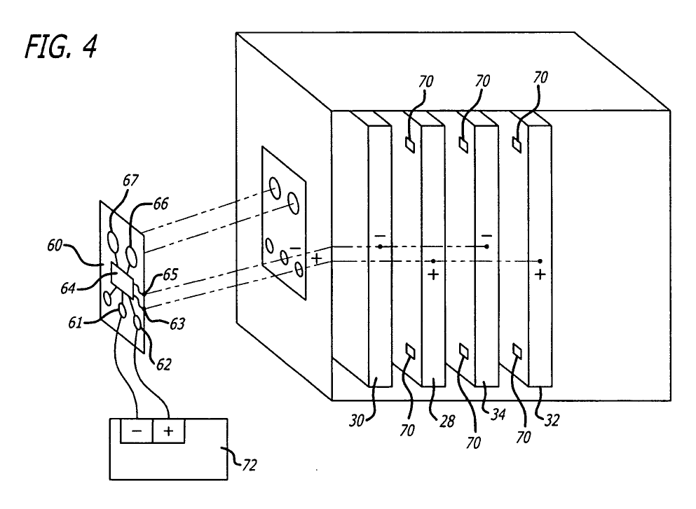

As shown schematically in FIG. 4, the housing 10 may hold an electrolyzer comprising a number of metal plates 28, 30, 32 and 34, some of which are used as anodes (28 and 32) and some as cathodes (30 and 34) in the electrolysis process. In addition, the housing 10 can hold a fluid, such as water, which is used as the source of hydrogen for the electrolysis process. The water may be tap water, distilled water or water containing electrolytes. Other suitable water mixtures may also be used.

In addition, one side of the housing 10 can have a recessed section 36 that receives a mounting plate 40. The mounting plate 40 can hold a controller 60 and other components (described below) which will provide various functions for the system. Alternatively, the controller 60 may be located remotely from the housing 10, and be coupled to the components in the housing 10 via the mounting plate 40. The mounting plate 40 can be attached by screws or other fasteners to the recessed section 36 of the housing 10. As shown, the mounting plate 40 has openings 42 and 44 for mounting or holding sensors or sensor leads. The sensors communicate with the interior of the housing 10 via holes in the side of the housing 10. The mounting plate 40 may also have openings 46 and 48 for coupling a positive lead 63 and a negative lead 65 from the controller's power output to the plates within the housing 10. More or fewer openings may be provided in mounting plate 40 depending on how many sensors and components are used.

One side of the housing 10 may also have a groove 50. The groove 50 can be located on any side of housing 10 that is visible when mounted to a vehicle. The groove 50 may receive a tube (not shown) made of transparent material, such as glass or clear plastic. The interior of the tube may be in fluid communication with the interior of the housing 50 via a hole 52 at the base of the tube. The tube thus may serve as a visual indicator of fluid level inside the housing 50.

The housing 10 may also include a drain hole 54 at the bottom of the tapered section 18 for draining fluid and/or sediment out of housing 10. The tapered section 18 provides space for sediment that may be within the fluid to collect. The drain hole 54 may be threaded so that a threaded cap (not shown) may be used to seal the drain hole 54. Alternatively, a moveable seal (not shown), such as a valve or flap, may be associated with the drain hole 54. The seal may have an open position and a closed position, such as a valve or a flap. The seal may be moved manually or automatically if certain conditions are detected within the housing 10.

As shown in the schematic drawing of FIG. 4, controller 60 has power inputs 61 and 62 which can be connected or coupled to the battery 72, and power outputs 63 and 65 which can be connected or coupled to the electrolyzer plates. The metal plates 28 and 32 function as anodes of an electrolyzer because they are coupled in series, via the controller power output 63, to the positive leads of the power source or battery 72. Similarly, plates 30 and 34 function as cathodes because they are coupled in series, via the controller power output 65, to the negative leads of the power source or battery 72. Two anodes and two cathodes are shown in the schematic diagram. However, in a housing that is 12×12×6 inches, for example, there could be 14 plates total (7 anodes and 7 cathodes), but there could be anywhere from between 10 plates and 30 plates. The plates may also be about 11 inches tall by 4 inches wide. Of course, other dimensions and numbers of plates are contemplated.

The electrolyzer uses direct current to separate water molecules into a mixture of hydrogen and oxygen gas, sometimes referred to as HHO or Brown's gas. The HHO gas is then delivered to the internal combustion engine via the output port or duct 23 in the top of the housing.

The controller 60 may include a processor 64, which may comprise one or more chips, with a pulse width modulator for adjustably controlling the frequency and wavelength of power provided to the controller's input drawn from the battery or power source 72, and a converter for converting twelve volt (12 VDC) or twenty-four volt (24 VDC) direct current supplied by the battery or power source 72 into direct current at a nominal one hundred forty-four volt (144 VDC) power controlled (“constant power source”) output provided at the controller's output under expected operating conditions. The converter is adapted to operate with an input voltage between eleven volts (11 VDC) and thirty six volts (36 VDC) at the converter input connection. The nominal input voltage is expected to be about fourteen volts (14 VDC). The converter is adapted to provide an approximately constant output power consistent with a maximum voltage of one hundred forty-four volts (144 VDC) (nominal) and a maximum current of about four amps (4 ADC) at the controller's output, which can then be supplied to the electrolyzer plates. The load within the converter consists of a resistive device with a resistance of not less than 17 Ohms. The rate of change of the load within the converter is designed not to exceed 10% per minute. In one example, the converter smoothly transitions from providing a maximum allowed output voltage of one hundred forty-four volts (144 VDC) to a constant power configuration until the current reaches the maximum allowed value of about four amps (4 ADC). At that point, the converter smoothly transitions to a constant current mode with a nominal setting of about four amps (4 ADC).

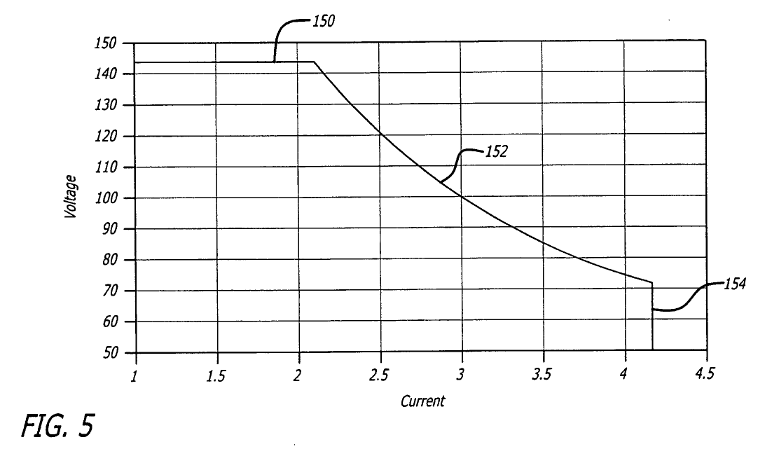

Turning to FIG. 5 the output modes of the converter are depicted. The converter has three main operational modes, shown as a constant voltage region 226, a constant power region 228, and a constant current region 230. The constant voltage region 226 has a voltage of about one hundred forty-four volts (144 VDC). The constant power region 228 has a power of about three hundred watts (300 w). Finally, the constant current region has current of about four amps (4 ADC). Other values can be used or designed. The mode in which the converter operates may depend on the conditions within the system. For example, the temperature of the system, the amount of water in the housing and the amount of sediment in the housing, each may affect the efficiency of the electrolyzer, and thus the output mode of the converter. Data or information about the system's temperature or fluid level, or other information, may be provided to the controller via one or more sensors. Based on this information, the controller may adjust or control the controller's power output and/or input.

The frequency and wavelength of the current provided to the electrolyzer from the controller is preferably a square wave or substantially a square wave. The pulse width modulator in the controller may be adjustably tuned for each individual vehicle to provide maximum efficiency for HHO generation.

Referring back to FIG. 4, a fluid sensor (not shown) may be positioned within the housing 10 when the mounting plate 40 and controller 60 are attached to the housing 10. The fluid sensor can also be coupled to the processor 64 on the controller 60 by an input 67. The fluid sensor may detect the presence or absence of fluid within housing 10. Based on whether or not fluid is detected, the sensor sends a first signal to processor 64 when fluid is detected, and sends a second signal to processor 64 when fluid is not detected. If the processor 64 receives a signal that no fluid is detected by the sensor, then the processor 64 may cause the power to be shut off to the electrolyzer to prevent overheating. The low fluid sensor may be placed within opening 42 or 44 in mounting plate 40, or it may be placed at any desired location inside housing 10 and coupled to the controller 60. For example, the low fluid sensor may be located above the mid-point of the height of plates 28, 30, 32 and 34.

Similarly, a thermostat (not shown) may be attached to the mounting plate 40 and coupled to controller 60 by an input 66. The thermostat sends a signal to processor 64 corresponding to the temperature detected inside housing 10. The processor 64 may shut off power to the electrolyzer if the temperature signal exceeds a predetermined threshold. For example, the power output may be shut off if the system's temperature exceeds 220 degrees, and will not be turned on until the temperature drops below 190 degrees. The thermostat may be located in opening 42 or 44 of the mounting plate 40, or it may be located inside housing 10.

The housing 10 may include a pressure sensor (not shown) located inside the housing 10 that is coupled to the processor 64 at another input. The pressure sensor sends a signal to processor 64 corresponding to the pressure detected inside housing 10. The processor 64 may shut off power to the plates 28, 30, 32 and 34 if the pressure signal exceeds a predetermined threshold. The pressure sensor may be located in opening 42 or 44 of the mounting plate 40, or it may be located inside housing 10.

The housing 10 may also include a sensor (not shown) for detecting the presence of sediment inside the container. The sensor may be coupled to processor 64, and sends a first signal to processor 64 if sediment is not detected, and sends a second signal to processor 64 if sediment is detected. The processor 64 may be coupled to drain hole 54. Processor 64 may cause a moveable seal (not shown) in drain hole 54 to open if it receives the second sediment detected signal from the sensor. If the second signal is sent, the controller 60 and/or processor 64 may cause the power to the system to shut off as described above. The sensor or controller also may be directly coupled to a motor associated with the drain hole 54 and may causes a moveable seal (not shown) to open the drain hole 54 if sediment is detected. The sediment sensor may be located in opening 44 or 46 of the mounting plate 40, or it may be located inside the housing 10. If the sediment sensor is located inside the housing, it may be located near the bottom of the main section 16, or near the top of the tapered section 18 of housing 10, or near the bottom of the plates 28, 30, 32 and 34.

The various sensors described above may be coupled to one or more relays (not shown) instead of a chip, which can operate to shut off power to the electrolyzer in the event the sensors detect the conditions described above.

The plates 28, 30, 32 and 34 may be made of stainless steel, more preferably 316L grade stainless steel. The plates 28, 30, 32 and 34 may be about 0.030 inches thick and spaced about 0.056 inches apart. Spacing of plates 28, 30, 32 and 34 may be maintained by vibration resistant bushings 70, such as polyurethane bushings.

The controller 60 also may be coupled to a display screen (not shown) located inside a vehicle to inform the operator of the various signals received by the controller. For example, the display screen could display the temperature and pressure inside the housing 10. The display screen could also include indicators for low fluid level, or sediment accumulation inside the housing 10, indicating the system needs to be serviced.

The system may optionally be coupled to a satellite system, enabling remote monitoring of system parameters such as temperature, pressure, and fluid and sediment level.

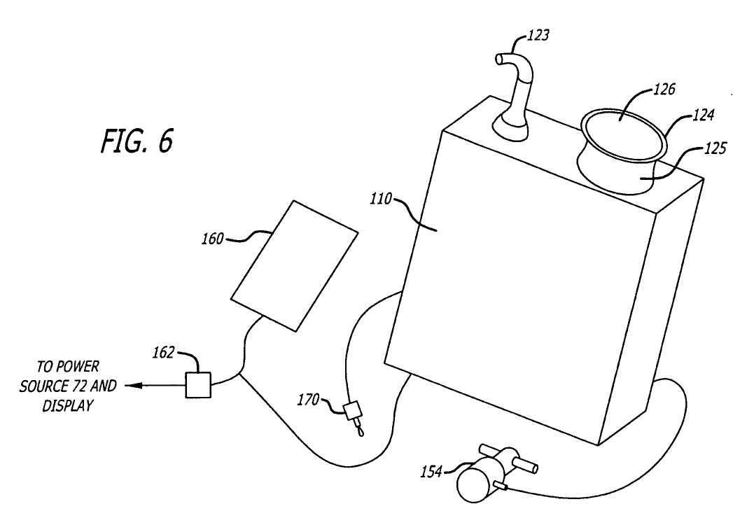

FIG. 6 shows another example of a hydrogen generation system. As shown in this example, the housing is a unitary or enclosed housing 110. The system may include a port or duct 123, which can be coupled, via tubing for example, to the engine to supply hydrogen gas to the engine. The housing 110 can be sealed by a cap 124, that is threaded onto a base 125 affixed to the housing 110. The cap 124 can have a dual o-ring pressure seal 126 which is designed to detach from the cap 124 when the internal pressure within the housing 110 exceeds a certain predetermined level. When the cap 124 is removed, water or other fluid may be added to the housing 100. After the fluid has been added, the cap 124 can be replaced to prevent the fluid from leaking out of the housing 110.

A drain valve 154 may be provided which can be connected to the housing 110 to drain the system. The valve 154 may be controlled manually or electronically, as described above.

Inside the housing 110 is an electrolyzer or electrolyzer plates as described above. A toggle switch 170 may also be provided to turn the electrolyzer on and off. When turned on, the electrolyzer may be controlled by an electronic control or controller 160 which is coupled to the electrolyzer. The electronic control 160 may be similar to the controller 60 described above. The electronic control 160 may be coupled to a plug 162, which is used to couple the electronic control 160 to the battery or power source (not shown) and a vehicle's display screen.

A thermostat or heat sensor (not shown), may be provided inside the housing, and coupled to the electronic control unit, as described above with respect to thermostat 66. Other sensors described above (e.g., pressure sensors) may also be provided.

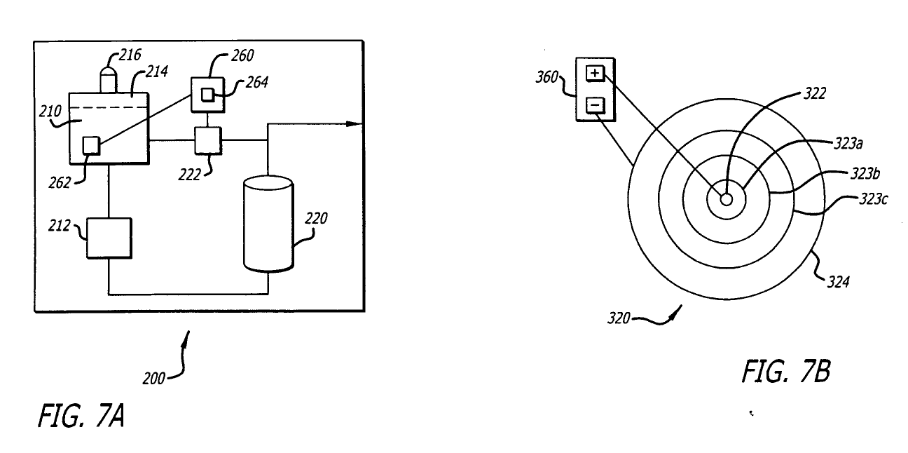

FIG. 7A is a schematic diagram of another example of a system. In this example, a fluid reservoir 210 and an electrolyzer 220 are located inside a housing 200. A controller 260 may be attached to the reservoir 210, the container 220, or to the side of the housing 200 via a mounting plate (not shown). The fluid inside the reservoir 210 is in communication with a pump 212 and the electrolyzer container 220. The pump 212 circulates fluid through the reservoir 210 and the electrolyzer container 220. The reservoir 210, pump 212 and electrolyzer 220 may be coupled by ducts, pipes, tubes, hard lines, or any other suitable connector.

The electrolyzer 220 may be coupled to the air intake of an internal combustion engine (not shown). The coupling may be ducting, tubing, hard lines, or any other suitable connector. Circulation of fluid cools both the fluid and the electrolyzer's components. Circulation of fluid also forces HHO gas generated by electrolyzer out of the electrolyzer 220 and into the air intake of an internal combustion engine (not shown). While only one electrolyzer 220 is shown in the schematic diagram of FIG. 7A, more than one may be used in such a system, connected in parallel between the pump 212 and fluid reservoir 210 similar to the electrolyzer 220.

The fluid reservoir 210 may include a top portion 214, with a hole 216 in a top surface. The hole 216 can be used to fill or refill the fluid reservoir 210 with fluid. The fluid reservoir 210 also may include a hole for receiving a fluid sensor 262. A fluid sensor 262 may detect the presence or absence of fluid within housing 200. The fluid sensor 262 may be coupled to a processor 264, comprising one or more chips, located on the controller 260 or to a relay (not shown). Based on whether or not fluid is detected, the sensor 262 sends a first signal to processor 264when fluid is detected, and sends a second signal to processor 264 when fluid is not detected. If the processor 264 receives a signal that no fluid is detected by the sensor, then the processor 264 may cause the power to be shut off to the electrolyzer to prevent overheating. Alternatively, the relay would shut off power to the electrolyzer if no fluid was detected.

Although the low fluid sensor 262 may be placed at any desired location, it may be located above the coupling between the electrolyzer 220 and the fluid reservoir 210. The low fluid sensor 262 may be placed near the bottom of fluid reservoir 210.

In this example, the processor 264 may be coupled to a flow sensor 222, or to a relay (not shown). The sensor 222 detects changes in fluid flow, and thus detects whether the pump 212 is operating to circulate fluid at a desired flow rate. If the flow rate is above the desired threshold, the sensor 222 sends a first signal to processor 264. If the flow rate is below the desired threshold, sensor 222 sends a second signal to processor 264. If processor 264 receives a signal indicating flow rate lower than expected, the processor 264 may cause power to be shut off to the electrolyzer to prevent overheating. Alternatively, the relay would shut off power to the electrolyzer if a lower than desired flow rate was detected.

As shown in FIG. 7B, in this example, the electrolyzer 320 includes a central rod 322 connected via controller 360, similar to controller 60, to the positive leads of the power source or battery (not shown), and is used as an anode for the electrolyzer 320. The rod 322 is surrounded by uncharged tubes 323a, 323b and 323c, the number and spacing of which may vary. The tubes 323a, 323b and 323c are preferably made of stainless steel, more preferably grade 316L stainless steel. The outermost tube 324 is connected via controller 60 to the negative leads of the power source or battery, and is used as a cathode for the electrolyzer. The rod 322, tubes 323a, 323b, and 323c and tube 324 are preferably made of stainless steel, more preferably grade 316L stainless steel. The rod 322 may be threaded.

While the foregoing has described what are considered to be the best mode and/or other examples, it is understood that various modifications may be made therein and that the technology disclosed herein may be implemented in various forms and examples, and that they may be applied in numerous applications, only some of which have been described herein. It is intended by the following claims to claim any and all modifications and variations that fall within the true scope of the advantageous concepts disclosed herein.

What is claimed is:

1. A hydrogen fuel enhancement system for an internal combustion engine, comprising:
a housing;
an electrolyzer, the electrolyzer having at least one anode and one cathode located within the housing;
a controller, the controller having an input and an output, the controller output being coupled to the electrolyzer;
the controller comprising a pulse width modulator for adjustably controlling the frequency and wavelength of power drawn by the controller, and a converter for providing an approximately constant power output from the controller.

2. The system of claim 1 wherein the anode and the cathode of the electrolyzer comprise metal plates.

3. The system of claim 2 wherein the metal plates comprise stainless steel plates and are spaced approximately 0.056 inches apart.

4. The system of claim 2 wherein a low fluid sensor is located inside the container and is coupled to the controller, and further wherein the low fluid sensor sends a first signal to the controller when fluid is detected, and sends a second signal to the controller when fluid is not detected

5. The system of claim 4, wherein the low fluid sensor is located near the vertical mid-point of the metal plates.

6. The system of claim 1, wherein a thermostat is located inside the container and is coupled to the controller.

7. The system of claim 6, wherein the controller sends a signal to the controller causing the controller to prevent power from passing to the electrolyzer if the detected temperature exceeds a predetermined threshold.

8. The system of claim 1, wherein a sensor for detecting the presence of sediment is located inside the container, and is coupled to the controller, wherein the sensor sends a first signal to the controller if no sediment is detected, and sends a second signal to the controller if sediment is detected.

9. The system of claim 8, wherein the sensor is located near the bottom of the electrolyzer.

10. The system of claim 8, wherein a movable drain seal having and open position and a closed position is located near the bottom of the container, and the drain seal is coupled to the controller.

11. The system of claim 1 wherein a pressure sensor is located inside the container and sends a signal to the controller.

12. The system of claim 11 wherein the controller prevents power from passing to the electrolyzer if the signal from the pressure sensor exceeds a pre-determined threshold.

13. An electrolyzer for use with internal combustion engines comprising:
a plurality of anodes and cathodes,
a DC power source;
an electronic control, having an input coupled to the power source and an output coupled to at least one anode and cathode, the electronic control comprising a pulse width modulator circuit and a converter circuit, wherein the electronic control provides an approximately constant power output when supplied with a power input of between about 11 and 36 volts DC.
